(19) United States
(12) Patent Application Publication
(10) Pub. No.: US 2023/0138506 A1
(43) Pub. Date: May 4, 2023

(54) Wireless Power Transfer

(71) Applicant: Telefonaktiebolaget LM Ericsson (publ), Stockholm (SE)

(72) Inventor: Gang Zou, Lund (SE)

(21) Appl. No.: 17/766,755

(22) PCT Filed: Oct. 7, 2019
(86) PCT No.: PCT/EP2019/076988

§ 371 Date: Apr. 6, 2022

(51) Int. Cl. H02J 50/27; H02J 50/40

(52) U.S. Cl. CPC H02J 50/27; H02J 50/402

(57) ABSTRACT

A radio frequency power recovery unit, comprises a plurality of rectennas, each comprising an antenna and a capacitor configured to be charged by energy received by the antenna; a plurality of switches, each configured to selectively connect a respective one of the plurality of rectennas to an energy storage device, such that the respective capacitor is charged by energy received by the ntenna while the respective switch is open, and such that the respective capacitor is discharged to the energy storage device while the respective switch is closed; and a control unit, configured to selectively open and close the switches in a predetermined sequence.

### TECHNICAL FIELD

This relates to wireless power transfer, and in particular to a radio frequency power recovery unit, and a method of operation of such a unit.

### BACKGROUND

Radio frequency (RF) energy harvesting is capable of converting received RF signals into electricity. One use of RF energy harvesting is to allow wireless devices to obtain energy from RF signals, potentially removing the necessity for a large battery, and therefore reducing the size and weight of the device. This would increase the feasibility of concepts such as paper-thin, flexible displays, contact-lens-based augmented reality and smart dust etc.

The main element of a RF power receiver is a rectenna which converts RF power to DC power. However, a single rectenna may not harvest enough energy for the intended load. To solve this problem, a RF power receiver can be implemented with multiple rectennas (or a rectenna array with multiple rectenna elements) to extract energy with spatial-diversity within the same frequency band or to extract energy using different frequency bands.

The multiple rectennas may be connected in series or in parallel to sum their harvested RF energy. As the RF power is not evenly distributed among the rectennas, the output voltages generated by the rectennas can differ from one another. In that case, simply connecting the rectennas in series or in parallel may lead to poor RF-to-DC efficiency. For example, connecting all rectenna elements in series forces the rectennas to share the same output current. This does not allow them all operate at their individual maximum power point and high output impedance. On the other hand, connecting all rectennas in parallel may mean that most of rectennas stop rectifying as their rectifier circuit does not have enough forward voltage drop to overcome the turn-on threshold voltage.

### SUMMARY

According to an aspect of the invention, there is provided a radio frequency power recovery unit, comprising:
a plurality of rectennas, each comprising an antenna and a capacitor configured to be charged by energy received by the antenna;
a plurality of switches, each configured to selectively connect a respective one of the plurality of rectennas to an energy storage device, such that the respective capacitor is charged by energy received by the antenna while the respective switch is open, and such that the respective capacitor is discharged to the energy storage device while the respective switch is closed; and
a control unit, configured to selectively open and close the switches in a predetermined sequence.

The predetermined sequence may be such that only one switch is closed at any one time.

The radio frequency power recovery unit may be for use with a transmitted radio frequency signal that is on for a first part of each cycle of the signal, and is off for a second part of each cycle of the signal, and the predetermined sequence may be such that at least one first rectenna is connected to the energy storage device during the first part of each cycle, and at least one second rectenna is connected to the energy storage device during the second part of each cycle.

The radio frequency power recovery unit may be for use with a transmitted radio frequency signal that is on for a first part of each cycle of the signal, and is off for a second part of each cycle of the signal, and a period of the predetermined sequence may be less than a duration of the first part of each cycle.

The radio frequency power recovery unit may be for use with a transmitted radio frequency signal that is on for a first part of each cycle of the signal, and is off for a second part of each cycle of the signal, and the control unit may be configured to selectively open and close the switches in a predetermined sequence during the second part of each cycle.

The radio frequency power recovery unit may be for use with a transmitted radio frequency signal that is on for a first part of each cycle of the signal, and is off for a second part of each cycle of the signal, and the control unit may be configured to selectively open and close the switches in a predetermined sequence during the first part of each cycle.

According to another aspect of the invention, there is provided a method of operation of a radio frequency power recovery unit, wherein the radio frequency power recovery unit comprises:
a plurality of rectennas, each comprising an antenna and a capacitor configured to be charged by energy received by the antenna; and
a plurality of switches, each configured to selectively connect a respective one of the plurality of rectennas to an energy storage device, such that the respective capacitor is charged by energy received by the antenna while the respective switch is open, and such that the respective capacitor is discharged to the energy storage device while the respective switch is closed;
the method comprising selectively opening and closing the switches in a predetermined sequence.

The predetermined sequence may be such that only one switch is closed at any one time.

The method may be for use with a transmitted radio frequency signal that is on for a first part of each cycle of the signal, and is off for a second part of each cycle of the signal, and the predetermined sequence may be such that at least one first rectenna is connected to the energy storage device during the first part of each cycle, and at least one second rectenna is connected to the energy storage device during the second part of each cycle.

The method may be for use with a transmitted radio frequency signal that is on for a first part of each cycle of the signal, and is off for a second part of each cycle of the signal, and a period of the predetermined sequence may be less than a duration of the first part of each cycle.

The method may be for use with a transmitted radio frequency signal that is on for a first part of each cycle of the signal, and is off for a second part of each cycle of the signal, and the method may comprise selectively opening and closing the switches in a predetermined sequence during the second part of each cycle.

The method may be for use with a transmitted radio frequency signal that is on for a first part of each cycle of the signal, and is off for a second part of each cycle of the signal, and the method may comprise selectively opening and closing the switches in a predetermined sequence during the first part of each cycle.

Thus, embodiments use a network of switches to connect multiple rectennas in a RF power receiver. A control unit generates the control signals to turn on/off the switches respectively. By turning on/off the switches in a proper control scheme, the efficiency of the RF harvesting system can be improved. In some embodiments, the switches are voltage-controlled switches.

The disclosed embodiments can improve the efficiency of a RF power transfer system, while also enabling a simple, low-cost, and size-compact design of the RF power receiver.

### BRIEF DESCRIPTION OF THE DRAWINGS

FIG. 1 shows a mobile device.

FIG. 2 shows a power recovery unit in the mobile device of FIG. 1.

FIG. 3 shows details of the power recovery unit of FIG. 2.

FIG. 4 illustrates the operation of the power recovery unit.

FIG. 5 illustrates in more detail the operation of the power recovery unit.

FIG. 6 illustrates the operation of the power recovery unit in an alternative embodiment.

FIG. 7 shows details of the construction of a power recovery unit.

### DETAILED DESCRIPTION

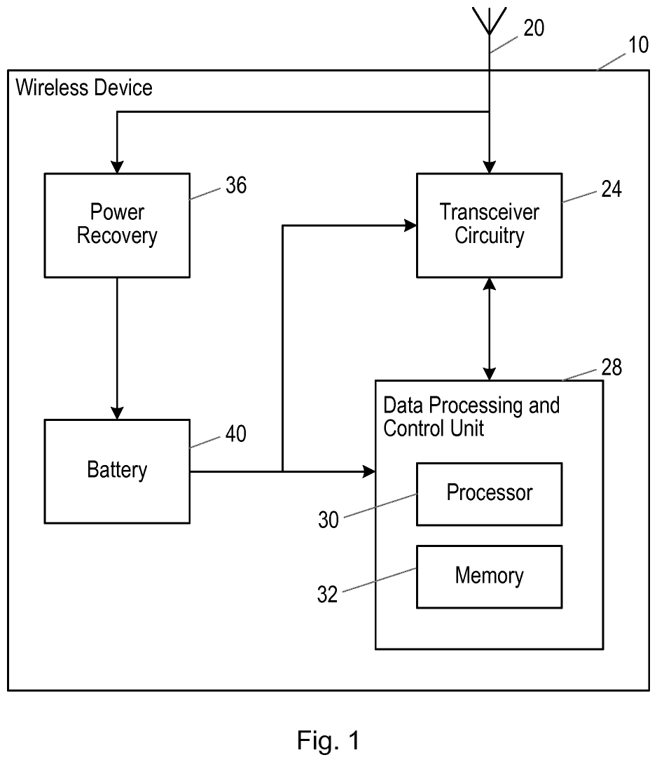

FIG. 1 illustrates a wireless device 10. By way of illustration only, in this embodiment the wireless device takes the form of a smartphone, though it will be appreciated that the disclosure herein could be applied equally to any other wireless or mobile device. For example, the wireless device may be a wireless sensor or another Internet of

Things device.

The wireless device 10 includes an antenna 20, configured for receiving and transmitting wireless signals at radio frequencies. The antenna 20 is connected to transceiver circuitry 24, which generates signals suitable for transmission, and processes received signals. The transceiver circuitry 24 is connected to a data processing and control unit 28, which includes a processor 30 and a memory 32. The memory 32 may store operating data and programs for controlling the operation of the processor 30, which controls the functionality of the wireless device 10. It will be appreciated that a wireless device 10 will also include other components, such as transducers or a user interface, as required, depending on the intended functionality of the device, but these other components are not shown in FIG. 1 for reasons of clarity.

In addition, the wireless device 10 includes a power recovery unit 36. In the illustrated embodiment, the power recovery unit 36 is connected to the antenna 20, which is provided for the purpose of receiving communication signals. In other embodiments, the power recovery unit may be connected to one or more different antenna. In embodiments where the wireless device is a mobile device that does not have a communication function, and does not have an antenna for communication purposes, one or more antenna may be provided specifically for connection to the power recovery unit 36.

The power recovery unit 36 is connected to an energy storage unit 40, for example in the form of a rechargeable battery, which may or may not also be connected to another power source. The energy storage unit 40 is a source of power for the transceiver circuitry 24, the data processing and control unit 28, and the other components of the device 10.

Where the wireless device has a low power consumption, most or all of the power required by the device may be generated by the power recovery unit, and so it may be sufficient to provide an energy storage unit 40 in the form of a battery with a relatively small energy storage capacity, or the battery may be replaced by an alternative energy storage device, such as a supercapacitor. This reduces the size and weight of the device, making it possible to incorporate a thin, flexible display in the device, or making very small portable devices possible.

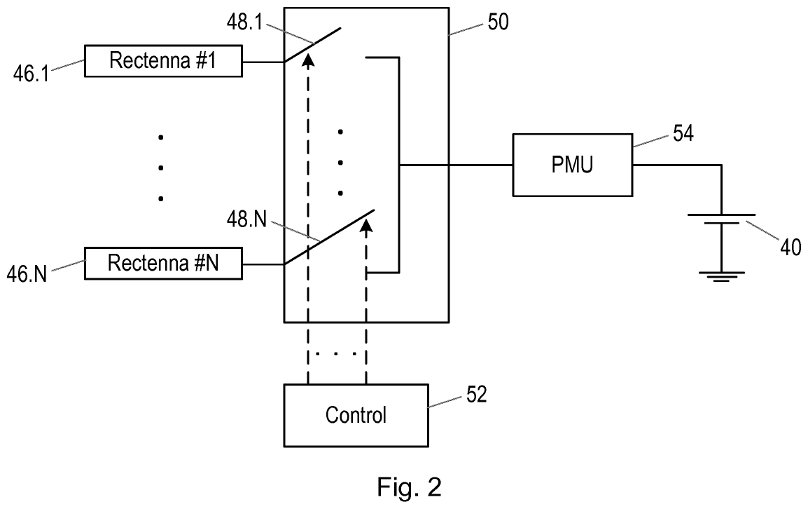

FIG. 2 shows in more detail the form of the power recovery unit 36.

Specifically, FIG. 2 shows a plurality of rectennas 46.1, . . . , 46.N, with each rectenna connected to a respective switch 48.1, . . . , 48.N of a switch block 50, where the switches 48.1, . . . , 48.N are each controlled by a control block 52.

When the respective switch is closed, each rectenna may be connected to a power management unit 54, which in turn is connected to the energy storage unit 40 in order to provide power to the energy storage unit 40 and charge it up, so that the stored energy may be used to power the operation of the mobile device 10.

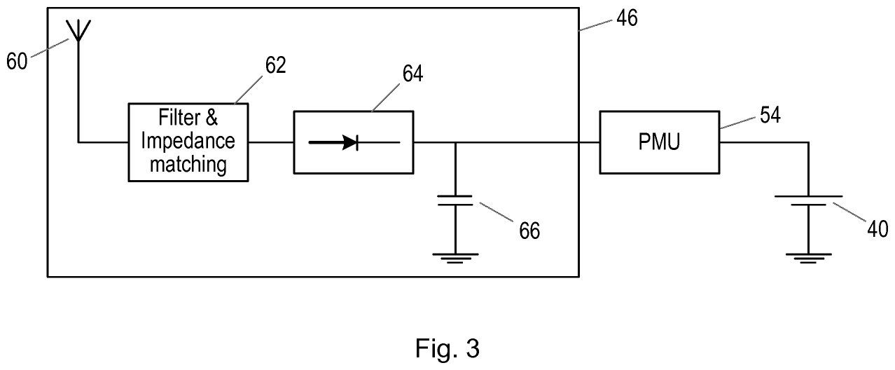

FIG. 3 shows in more detail the structure of one rectenna 46.

Specifically, FIG. 3 shows a rectenna 46 that includes an antenna 60, which is connected to a filter and impedance matching circuitry 62, with the filtered signal being passed to a rectifier 64, typically including at least one diode. An output of the rectifier 64 is connected to ground through a smoothing capacitor 66, and in this illustration (ignoring the switching block 50) it is also connected to the power management unit 54, which as before is connected to the energy storage unit 40, which as before may be a rechargeable battery, a supercapacitor, or any suitable device. As described with reference to FIG. 2, the power management unit 54 may further regulate the output voltage, and it charges the energy storage unit.

As shown in FIG. 2, there are multiple rectennas (or a rectenna array with multiple rectenna elements) 46.1, . . . , 46.N. The respective antennas of the multiple rectennas may for example be designed to receive signals from different directions, so that the power recovery unit is able to extract energy from those different directions, that is, with spatial diversity within the same frequency band. Alternatively, the filters in the respective filter and impedance matching blocks of the multiple rectennas may be designed to pass signals at different frequency bands, so that the power recovery unit is able to extract energy from different frequency bands. It is also possible that different rectennas may be able to extract energy from different directions and at different frequency bands.

As mentioned above, FIG. 2 shows a plurality of rectennas 46.1, . . . , 46.N, with each rectenna connected to a respective switch 48.1, . . . , 48.N of a switch block 50, where the opening and closing of each switch 48.1, . . . , 48.N is controlled by a control block 52. The control unit can be implemented with either a digital circuit or an analog circuit. When a switch is closed, the respective rectenna may be connected to the power management unit 54, so that the energy stored in the capacitor of that rectenna may be used.

In embodiments of the disclosure, the control block 52 is configured to selectively open and close the switches 48.1, . . . , 48.N in a predetermined sequence.

Specifically, in some embodiments, the control block 52 can be configured to ensure that only a subset of the switches 48.1, . . . , 48.N is turned on at any one time. For example, in some embodiments, only one of the switches 48.1, . . . , 48.N is turned on at any one time, so that only one rectenna is connected to the PMU. The switches can be turned on and off in a round-robin sequence, and the sequence may be predetermined.

Then, while one rectenna is connected to PMU and charging the energy storage unit 40, the other rectennas are disconnected from the PMU, but their rectifier circuits 64 can still be running, and their capacitors 66 will be charged. When that first rectenna is disconnected from the PMU, a second rectenna is connected to the PMU. The rectifier circuit 64 of the first rectenna will continue to operate, and its capacitor 66 will be charged, while the capacitor 66 of the second rectenna will discharge so that energy harvested while the second rectenna was not connected to the PMU can be used.

Connecting only one rectenna to the PMU at any one time avoids the disadvantage that, if multiple rectennas are connected, the voltage generated by one of the rectennas can mean that the required forward voltage of the rectifier in another rectenna is not reached, preventing this rectenna from operating. Therefore, connecting only one rectenna to the PMU at any one time means that the RF energy collected from all rectennas can be rectified and fed to the PMU. This can improve the RF-to-DC converting efficiency of the RF power recovery unit.

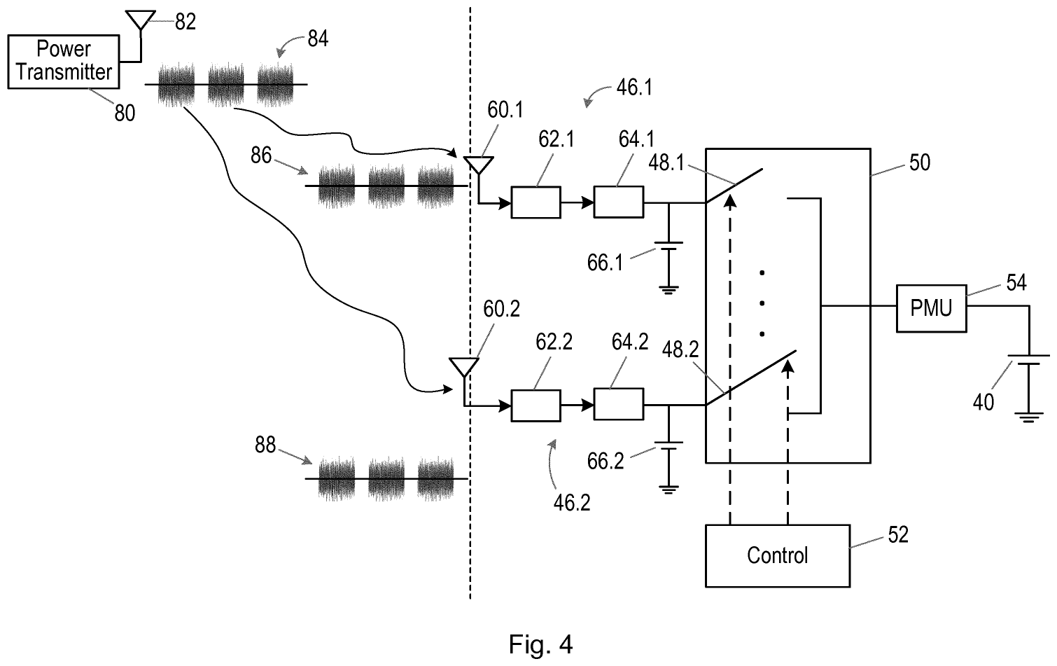

FIG. 4 shows an embodiment in which the power recovery unit shown in FIG. 2 is used for recovering energy from a dedicated energy source that generates and transmits a RF signal for RF power transfer.

Specifically, FIG. 4 shows a system in which a power transmitter 80 generates a RF signal that is transmitted via an antenna 82. Specifically, in this embodiment, the waveform of the RF signal 84 has a duty cycle (T) and an active signal duration (W) where W<T.

The power recovery unit in this example comprises two rectennas 46.1, 46.2, each with an antenna 60.1, 60.2, filter and impedance matching circuitry 62.1, 62.2, a rectifier 64.1, 64.2, and a smoothing capacitor 66.1, 66.2, as described previously. The rectennas are connected through switches 48.1, 48.2 of the switching block 50 (operating under the control of the control unit 52) to the power management unit 54, which as before is connected to the energy storage unit 40,

FIG. 4 also shows an example where, for example because the antennas 60.1, 60.2 are oriented differently, and because of the orientation of the device, the signal 86 received by the one antenna 60.1 is of higher amplitude than the signal 88 received by the other antenna 60.2.

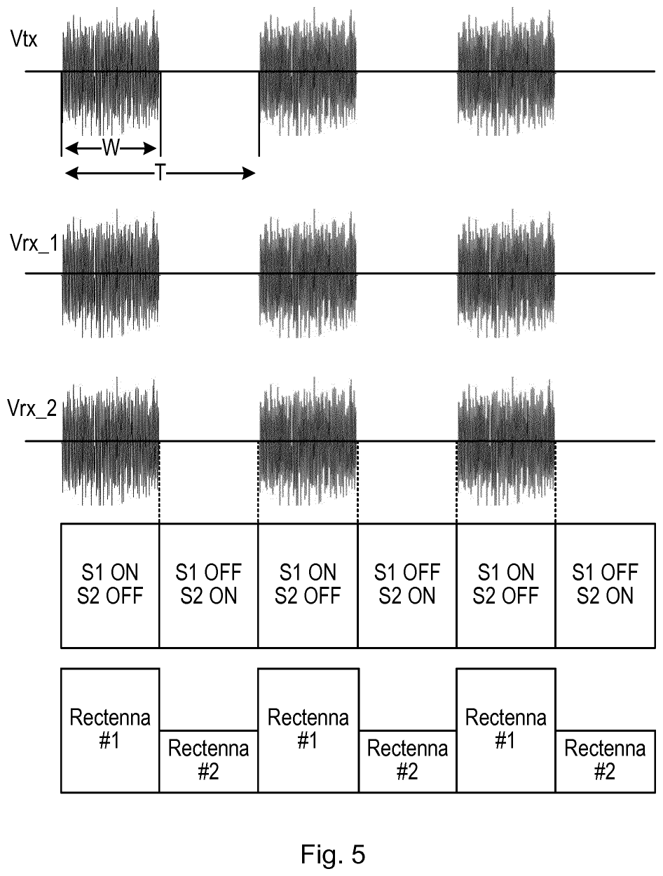

FIG. 5 shows the operation of this embodiment.

Specifically, FIG. 5 shows the transmitted signal Vtx, with the duty period T and active signal duration W, where W<T.

FIG. 5 also shows the signal Vrx_1 received by the antenna 60.1 of the first rectenna 46.1 and the signal Vrx_2 received by the antenna 60.2 of the second rectenna 46.2.

In this embodiment, the switching duty cycle of the switches in the switching block 50 is set to align with the duty cycle of the incoming RF signal.

As noted above, the signal received by the first rectenna 46.1 is stronger than the signal received by the second rectenna 46.2, and this will mean that the first rectenna generates a higher output voltage than the second rectenna. If the two rectennas were connected in parallel, then, during the active signal duration, the second rectenna would stop rectifying as its forward voltage drop would be reduced because of the higher output voltage from the first rectenna. As a result, the RF energy collected by the second rectenna could not be stored or used.

Therefore, in this embodiment, during the active signal duration W, the controller turns on the switch 48.1 and turns off the switch 48.2. The first rectenna 46.1 is supplying energy to the PMU 54 while the second rectenna 46.2 is rectifying and storing RF energy in its capacitor 66.2. When the transmitter stops transmitting the RF signal (i.e. during the period T-W), the controller turns off the switch 48.1 and turns on the switch 48.2. The PMU 54 is supplied from the capacitor 66.2 in the second rectenna 46.2, while the first rectenna 46.1 is rectifying and storing RF energy in its capacitor 66.1. So, compared with simply connecting both rectennas in parallel, this embodiment can additionally store and use the RF energy collected by the second rectenna, meaning that the efficiency of the whole RF power transfer system is improved.

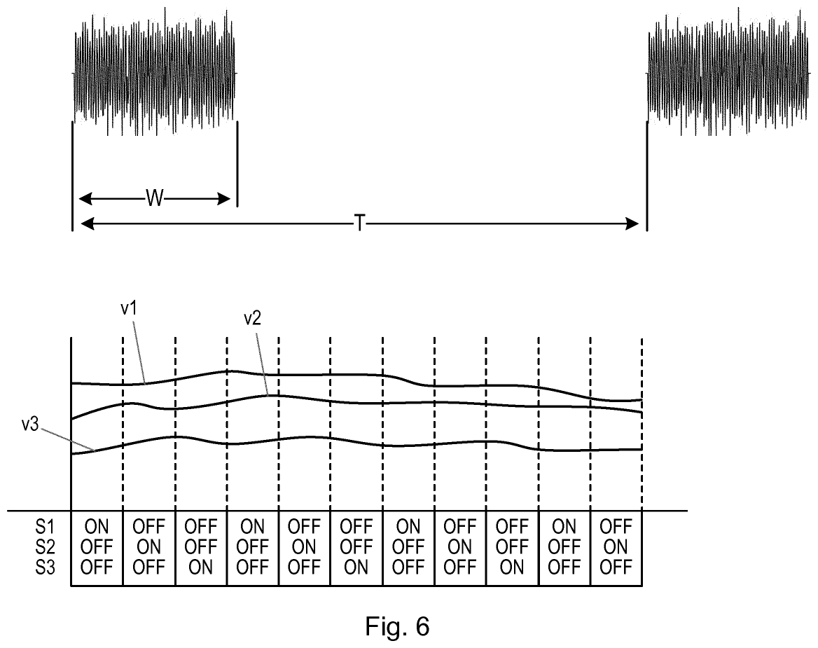

FIG. 6 shows the operation of a power recovery unit 36 in an alternative embodiment.

Specifically, FIG. 6 shows the operation of a power recovery unit having three rectennas. The rectennas generate respective output voltages v1, v2, and v3, and the rectennas are connected to the power management unit by respective switches S1, S2, and S3. Again, the transmitted signal has a duty period T and active signal duration W, where W<T.

In the operation shown in FIG. 6, the switches S1, S2, and S3 are opened and closed in a predetermined sequence, such that only one switch is turned on at any one time, in the order S1, S2, S3, S1, etc. The switches are controlled such that the period of the switching sequence (that is, the time taken for each switch to be closed once) is less than or equal to the active period W of the transmitted signal. In this embodiment, the switches are opened and closed in a predetermined sequence during the active period W. Also, in this embodiment, the switches are opened and closed in a predetermined sequence during the inactive period (T-W).

In other embodiments, the switches may be opened and closed in a predetermined sequence during only the active period or the inactive period, with for example a specific one of the switches being on during the other period.

Thus, each of the voltages v1, v2, and v3 on the respective capacitors 66 increases while the corresponding switch is open and the rectenna is charging the capacitor, but decreases while the corresponding switch is closed, allowing the capacitor to be discharged to the power management unit. The system is controlled so that none of the capacitors reaches the saturation voltage.

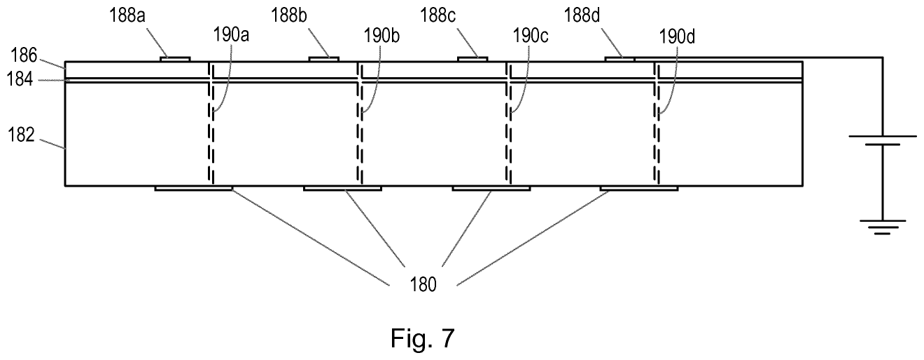

FIG. 7 shows one specific hardware implementation of a power recovery unit as previously described.

Specifically, multiple patch antenna elements 180 of an array are provided on an antenna substrate 182. The antenna elements 180 can for example be configured for receiving beamformed mmWave signals for RF power transfer. A ground plane 184 is provided between the antenna substrate 182 and a PCB substrate 186. Components 188a, 188b, 188c, 188d of the switch network and the power management unit can then be provided on the PCB substrate 186, with through hole via connections 190a, 190b, 190c, 190d to the patch antennas elements 180.

There is thus described a power recovery unit that can efficiently receive and store power recovered from RF signals.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference signs in the claims shall not be construed so as to limit their scope.

1.-12. (canceled)

13. A radio frequency power recovery unit, comprising:
a plurality of rectennas, each comprising an antenna and a capacitor configured to be charged by energy received by the antenna;
a plurality of switches, each configured to selectively connect a respective one of the plurality of rectennas to an energy storage device, such that the respective capacitor is charged by energy received by the antenna while the respective switch is open, and such that the respective capacitor is discharged to the energy storage device while the respective switch is closed; and
a control unit, configured to selectively open and close the switches in a predetermined sequence.

14. The radio frequency power recovery unit according to claim 13, wherein the predetermined sequence is such that only one switch is closed at any one time.

15. The radio frequency power recovery unit according to claim 13, for use with a transmitted radio frequency signal that is on for a first part of each cycle of the signal, and is off for a second part of each cycle of the signal,
wherein the predetermined sequence is such that at least one first rectenna is connected to the energy storage device during the first part of each cycle, and at least one second rectenna is connected to the energy storage device during the second part of each cycle.

16. The radio frequency power recovery unit according to claim 13, for use with a transmitted radio frequency signal that is on for a first part of each cycle of the signal, and is off for a second part of each cycle of the signal,
wherein a period of the predetermined sequence is less than a duration of the first part of each cycle.

17. The radio frequency power recovery unit according to claim 13, for use with a transmitted radio frequency signal that is on for a first part of each cycle of the signal, and is off for a second part of each cycle of the signal,
wherein the control unit is configured to selectively open and close the switches in a predetermined sequence during the second part of each cycle.

18. The radio frequency power recovery unit according to claim 13, for use with a transmitted radio frequency signal that is on for a first part of each cycle of the signal, and is off for a second part of each cycle of the signal,
wherein the control unit is configured to selectively open and close the switches in a predetermined sequence during the first part of each cycle.

19. A method of operation of a radio frequency power recovery unit, the method comprising:
selectively opening and closing switches of the radio frequency power recovery unit in a predetermined sequence;
wherein the radio frequency power recovery unit includes a plurality of rectennas, each comprising an antenna and a capacitor configured to be charged by energy received by the antenna, and said switches, each switch configured to selectively connect a respective one of the plurality of rectennas to an energy storage device, such that the respective capacitor is charged by energy received by the antenna while the respective switch is open, and such that the respective capacitor is discharged to the energy storage device while the respective switch is closed;
the method comprising selectively opening and closing the switches in a predetermined sequence.

20. The method according to claim 19, wherein the predetermined sequence is such that only one switch is closed at any one time.

21. The method according to claim 19, for use with a transmitted radio frequency signal that is on for a first part of each cycle of the signal, and is off for a second part of each cycle of the signal,
wherein the predetermined sequence is such that at least one first rectenna is connected to the energy storage device during the first part of each cycle, and at least one second rectenna is connected to the energy storage device during the second part of each cycle.

22. The method according to claim 19, for use with a transmitted radio frequency signal that is on for a first part of each cycle of the signal, and is off for a second part of each cycle of the signal,
wherein a period of the predetermined sequence is less than a duration of the first part of each cycle.

23. The method according to claim 19, for use with a transmitted radio frequency signal that is on for a first part of each cycle of the signal, and is off for a second part of each cycle of the signal,
wherein the method comprises selectively opening and closing the switches in a predetermined sequence during the second part of each cycle.

24. The method according to claim 19, for use with a transmitted radio frequency signal that is on for a first part of each cycle of the signal, and is off for a second part of each cycle of the signal,
wherein the method comprises selectively opening and closing the switches in a predetermined sequence during the first part of each cycle.
